(19) United States
(12) Patent Application Publication
(10) Pub. No.: US 2026/0141058 A1
(43) Pub. Date: May 21, 2026

(54) System and method for generating decoy data based on the detection of idle states of computing systems

(71) Applicant: Bank of America Corporation, Charlotte, NC (US)

(72) Inventors: Adam K. King, Fort Mill, SC (US); Matthew K. Bryant, Mt. Holly, NC (US); Peter Nein, Waxhaw, NC (US); Elizabeth Swanzy-Parker, Charlotte, NC (US); Sanjay Lohar, Mint Hill, NC (US); Natalie Sterling, Fort Mill, SC (US); Cara P. Bresnahan, LaGrange Park, IL (US)

(21) Appl. No.: 18/950,284

(22) Filed: Nov. 18, 2024

(51) Int. Cl. G06F 21/55

(52) U.S. Cl. CPC G06F 21/554; G06F 2221/034

(57) ABSTRACT

A system includes a memory configured to store activity state data associated with each of a plurality of hardware computing resources. The system further includes a processor operably coupled to the memory and configured to detect, based on the activity state data, an inactivity state associated with one or more hardware computing resources, and to generatively present sequences of different decoy data for processing by the one or more hardware computing resources. The processor is further configured to execute one or more generative machine-learning models trained to identify an adversarial user and to associate with the adversarial user each of the sequences of different decoy data and the execution of the one or more user interactions. The processor is further configured to execute store a log of the identified adversarial user, the sequences of different decoy data, and the execution of the one or more user interactions.

### TECHNICAL FIELD

The present disclosure relates generally to computing security, and, more specifically, to a system and method for generating decoy data based on the detection of idle states of computing systems.

### BACKGROUND

Certain web-based environments may include data being exchanged and stored across any number of computing systems and databases. For example, the data may include various user data or service data that may be stored to databases associated with respective entities, and that user data or service data may be exchanged between various centralized or decentralized servers and various computing systems for servicing end users. However, such web-based environments may be sometimes subjected to various threats and cyberattacks.

### SUMMARY

The system and methods implemented by the system as disclosed in the present disclosure provide technical solutions to the technical problems discussed above by generating decoy data based on the detection of idle states of computing systems. The disclosed system and methods provide several practical applications and technical advantages. Specifically, the present embodiments improve the security, reliability, maintainability, efficiency and performance of hardware computing resources, such as processors (e.g., central processing units (CPUs), graphic processing units (GPUs), artificial intelligence (AI) accelerators), storage (e.g., databases), network devices (e.g., hubs, routers, gateways, network interface cards (NICs), modems, repeaters, wireless access points (WAPs), and so forth), and memory (e.g., read-only memory (ROM), random-access memory (RAM), ternary content-addressable memory (TCAM), dynamic random-access memory (DRAM), static random-access memory (SRAM), and so forth), or other similar hardware computing resources that may be vulnerable to adversarial attacks during the time in which the hardware computing resources enter into an inactivity state (e.g., an idle state or a period of time in which “real” and “legitimate” tasks are not being performed).

Indeed, in accordance with the presently disclosed embodiments, upon the hardware computing resources being detected as having entered into the inactivity state (e.g., idle state), a cloud-based computing system may generatively present sequences of different decoy data to be processed by the hardware computing resources (e.g., processors, memory, storage, network devices, and so forth) in response to an execution of one or more user interactions with the hardware computing resources, and may further execute one or more generative artificial intelligence (AI) models trained to identify an adversarial user and to associate with the adversarial user each of the sequences of different decoy data and the execution of the one or more user interactions.

Specifically, the cloud-based computing system may include one or more decoy data generation algorithms that may be utilized to generatively present sequences of different decoy data (e.g., “fake” data) to be processed by the hardware computing resources during the inactivity state (e.g., idle state). For example, the sequences of different decoy data (e.g., “fake” data) may be processed by the hardware computing resources so as to deceive and prompt an adversarial user (e.g., an attacker, an eavesdropper, or other similar adversarial user) to interact and engage with the hardware computing resources in accordance with the decoy data (e.g., “fake” data) over some period of time in which the interactions and activities of the adversarial user are logged, stored, and maintained by the cloud-based computing system. Thus, the present embodiments may identify, isolate, and preempt potential adversarial attacks, cyberattacks, data breaches, or other security vulnerabilities that may be associated with hardware computing resources during the time in which the hardware computing resources enter into an inactivity state by dynamically and generatively constructing a responsive computing system environment to isolate and “trap” adversarial attackers.

Furthermore, in addition to improving the security, reliability, and maintainability of hardware computing resources, the present embodiments further improve the efficiency and performance of hardware computing resources (e.g., processors, memory, storage, network devices, and so forth). Specifically, the cloud-based computing system may include one or more prioritization algorithms that may be suitable for forgoing generatively presenting the sequences of different decoy data (e.g., “fake” data) in response to the cloud-based computing system initiating one or more performable tasks (e.g., “real” or “legitimate” tasks) to be executed by the hardware computing resources (e.g., processors, memory, storage, network devices, and so forth).

In this way, the one or more prioritization algorithms may ensure that “real” or “legitimate” performable tasks are prioritized over any generation of decoy data. Indeed, by the one or more prioritization algorithms prioritizing the execution of performable tasks (e.g., “real” or “legitimate” tasks) over the generation of sequences of different decoy data (e.g., “fake” data), the one or more prioritization algorithms may ensure that the efficiency and performance of the hardware computing resources (e.g., processors, memory, storage, network devices, and so forth) are improved (e.g., in terms of CPU clock cycles, processing speed, memory allocation, storage capacity, network bandwidth, data throughput, and so forth) with respect to executing all “real” and “legitimate” performable tasks.

The present embodiments are directed to systems and methods for generating decoy data based on the detection of idle states of computing systems. In particular embodiments, a system includes a memory may be configured to store activity state data associated with each of a plurality of hardware computing resources configured to execute at least one software application. In particular embodiments, the system further includes one or more processors operably coupled to the memory may be configured to detect, based at least in part on the activity state data, an inactivity state associated with one or more hardware computing resources of the plurality of hardware computing resources.

In particular embodiments, in response to detecting an inactivity state associated with one or more hardware computing resources, the one or more processors may be further configured to generatively present sequences of different decoy data for processing by the one or more hardware computing resources in response to an execution of one or more user interactions with the one or more hardware computing resources. For example, in one embodiment, the sequences of different decoy data may include one or more randomized patterns of one or more of a processor utilization, a memory allocation, an input/output (I/O) device access, or a network device traffic. In one embodiment, the sequences of different decoy data may include one or more sets of noise data configured to prompt the adversarial user to complete the execution of the one or more user interactions with the sequences of different decoy data.

In particular embodiments, in response to an initiation of the execution of one or more user interactions with the one or more hardware computing resources, the one or more processors may be further configured to execute one or more generative machine-learning models trained to identify an adversarial user and to associate with the adversarial user each of the sequences of different decoy data and the execution of the one or more user interactions. For example, in one embodiment, the one or more generative machine-learning models comprises one or more of a language model (LM), a large language model (LLM), a bidirectional and auto-regressive transformer (BART) model, a bidirectional encoder representations for transformer (BERT) model, or a generative pre-trained transformer (GPT) model.

In particular embodiments, prior to executing the one or more generative machine-learning models, the one or more processors may be configured to train the one or more generative machine-learning models based at least in part on a training data set of user data associated with one or more intended users of the at least one software application and a training data set of operational data associated with the one or more hardware computing resources. For example, in particular embodiments, the one or more processors may be configured to execute the one or more generative machine-learning models further trained to identify the adversarial user based at least in part on whether the execution of the one or more user interactions deviates from the training data set of user data associated with the one or more intended users of the at least one software application.

In particular embodiments, in response to determining at least a partial completion of the execution of the one or more user interactions with the one or more hardware computing resources, the one or more processors may be configured to store a log of the adversarial user, the sequences of different decoy data, and the execution of the one or more user interactions. In particular embodiments, the one or more processors may be configured to identify one or more performable tasks to be executed by the one or more hardware computing resources.

For example, in one embodiment, the identified one or more performable tasks may be associated with the execution of the at least one software application. In particular embodiments, while the identified one or more performable tasks is executed by the one or more hardware computing resources, the one or more processors may be configured to forgo generatively presenting the sequences of different decoy data for processing by the one or more hardware computing resources.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram of a cloud computing and hardware computing resources system, in accordance with certain aspects of the present disclosure;

FIG. 2 illustrates a diagram of an idle detection and decoy data generation architecture for generating decoy data based on the detection of idle states of computing systems, in accordance with one or more embodiments of the present disclosure; and

FIG. 3 illustrates a flowchart of an example method for generating decoy data based on the detection of idle states of computing systems, in accordance with one or more embodiments of the present disclosure.

### DETAILED DESCRIPTION

### Example System

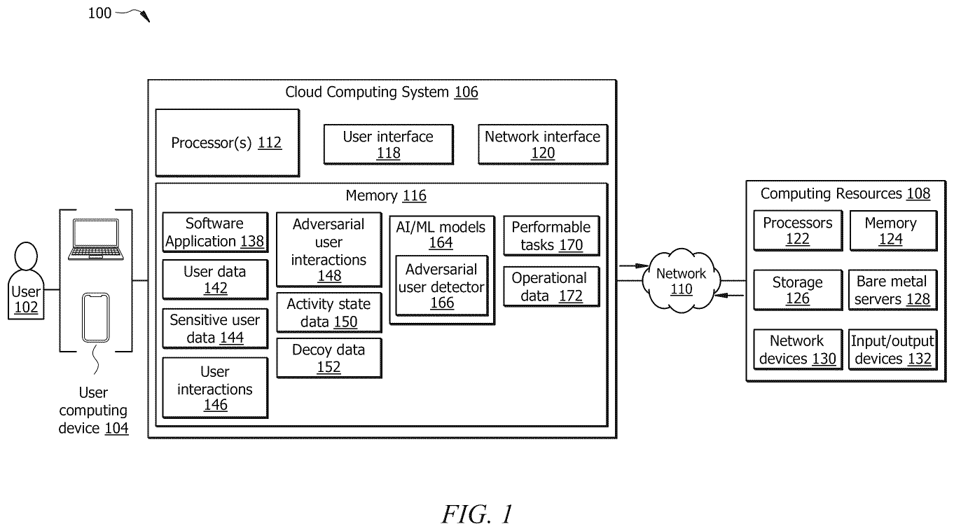

FIG. 1 is a block diagram of a cloud computing and hardware computing resources system 100. In particular embodiments, the system 100 may include a user computing device 104 associated with a user 102, a cloud computing system 106, hardware computing resources 108, and a network 110. In particular embodiments, the user 102 may include a user associated with an institution, an organization, or an entity that receives user data (e.g., user data 142) and hosts and maintain sensitive user data (e.g., sensitive user data 144) that may be associated with the user 102. The network 110 enables communications and exchanges of data among components of the system 100, such as the user computing device 104, the cloud computing system 106, and the hardware computing resources 108.

In general, the system 100 may be utilized to generate decoy data (e.g., decoy data 152) based on the detection of an inactivity state (e.g., idle state) of one or more of the hardware computing resources 108. As used herein, an “inactivity state” or an “idle state” may refer to a period of time in which “real” and “legitimate” tasks are not being executed by one or more of hardware computing resources 108 even though the hardware computing resources 108 (e.g., processors 122, memory 124, storage 126, bare metal servers 128, network devices 130, and input/output (I/O) devices 132) may each be activated (e.g., “ON”). For example, in one embodiment, in the “idle state,” the hardware computing resources 108 may each be programmed and/or configured to execute an idle task, which may include a sequence of repetitive instructions, such as an idle loop.

In particular embodiments, the cloud computing system 106 may include one or more processor(s) 112 in signal communication with a memory 116. The memory 116 stores software instructions 140 that when executed by the processor(s) 112, cause the processor(s) 112 to perform one or more functions described herein. For example, when the software instructions 140 are executed, the processor(s) 112 generates decoy data (e.g., decoy data 152) based on the detection of an inactivity state (e.g., idle state) of one or more of the hardware computing resources 108 in accordance with the presently disclosed embodiments.

The cloud computing system 100 may be configured as shown, or in any other configuration. In one embodiment, the cloud computing system 106 may include a private cloud computing and storage system, which may include, for example, a cloud computing environment and infrastructure that may be managed, controlled, and dedicated to a single organization or entity. In another embodiment, the cloud computing system 106 may include a hybrid cloud computing and storage system, which may include, for example, a mixed computing environment and infrastructure in which software applications are executing utilizing some combination of computing, storage, and services in both private cloud environments and public cloud environments. Still, in another embodiment, the cloud computing system 106 may include a public cloud computing and storage system, which may include, for example, a cloud computing environment and infrastructure that may be serviced to any number of organizations or entities as virtual resources accessible over the internet.

### System Components

### Network

The network 110 may be any suitable type of wireless and/or wired network, including, but not limited to, all or a portion of the Internet, an Intranet, a private network, a public network, a peer-to-peer network, the public switched telephone network, a cellular network, a local area network (LAN), a metropolitan area network (MAN), a wide area network (WAN), and a satellite network. The network 110 may be configured to support any suitable type of communication protocol as would be appreciated by one of ordinary skill in the art.

### Cloud Computing System

In particular embodiments, the cloud computing system 106 may include any computing system that may be utilized to process data and communicate with computing devices (e.g., user computing device 104), databases, or computing systems (e.g., hardware computing resources 108) via the network 110. The cloud computing system 106 may be utilized to oversee operations of the processor(s) 112. In particular embodiments, the cloud computing system 106 may include the processor(s) 112 in signal communication with a network interface 120, a user interface 118, and memory 116. The cloud computing system 106 may be configured as shown, or in any other configuration.

The processor(s) 112 may include one or more processors operably coupled to the memory 116. The processor(s) 112 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). The processor(s) 112 may be a programmable logic device, a microcontroller, a microprocessor, or any suitable combination of the preceding. The processor(s) 112 may be communicatively coupled to and in signal communication with the network interface 120, user interface 118, and memory 116. The one or more processors may be utilized to process data and may be implemented in hardware, software, or some combination thereof.

For example, the processor(s) 112 may be 8-bit, 16-bit, 32-bit, 64-bit or of any other suitable architecture. The processor(s) 112 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The one or more processors 112 are configured to implement various instructions. For example, the one or more processors may be utilized to execute software instructions 140 to implement the functions disclosed herein, such as some or all of those described with respect to FIGS. 1-3. In some embodiments, the function described herein is implemented using logic units, FPGAs, ASICs, DSPs, or any other suitable hardware or electronic circuitry.

The network interface 120 may be utilized to enable wired and/or wireless communications (e.g., via the network 110). The network interface 120 may be utilized to communicate data between the cloud computing system 106 and other network devices, systems, or domain(s). For example, the network interface 120 may comprise a WIFI interface, a local area network (LAN) interface, a wide area network (WAN) interface, a modem, a switch, or a router. The processor(s) 112 may be configured to send and receive data using the network interface 120. The network interface 120 may be configured to use any suitable type of communication protocol.

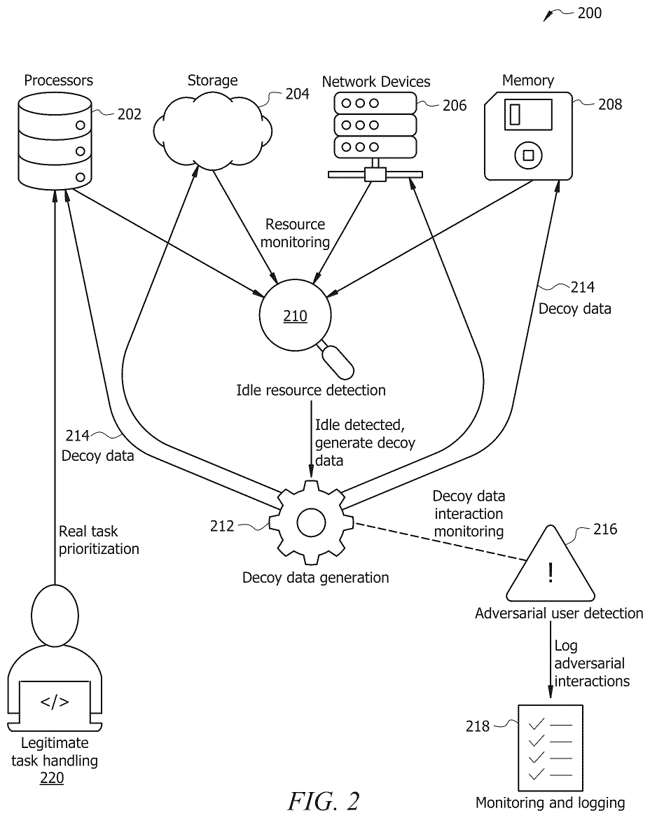

The memory 116 may be volatile or non-volatile and may include a read-only memory (ROM), random-access memory (RAM), ternary content-addressable memory (TCAM), dynamic random-access memory (DRAM), and static random-access memory (SRAM), or other non-transitory computer-readable medium. The memory 116 may be implemented using one or more disks, tape drives, solid-state drives, and/or the like. As will be discussed in greater detail below with respect to FIG. 2, the memory 116 may be operable to store the software instructions 140, user data 142, sensitive user data 144, user interactions 146, adversarial user interactions 148, activity state data 150, decoy data 152, one or more generative artificial intelligence (AI)/machine-learning models 164, adversarial user detector 166, one or more performable tasks 170, hardware computing resource operational data 172, and/or any other data, instructions, or compute engines.

The memory 116 may also store instances of software application 138 that may be executing within the system 100. In one embodiment, the instances of a software application 138 may include any number of instances a large software application suitable for hosting and servicing thousands or millions of individual users 102 that may interact via user computing devices 104 with the cloud computing system 106. The users 102 may be further associated with the sensitive user data 144.

### Processor(s)

In particular embodiments, the processor(s) 112 may generate decoy data 152 for processing by one or more of the hardware computing resources 108 based on the detection of an inactivity state (e.g., idle state) of one or more of the hardware computing resources 108. In particular embodiments, the processor(s) 112 monitor and ping each of processors 122 (e.g., CPUs, GPUs, AI accelerators), memory 124, storage 126 (e.g., databases), bare metal servers 128, network devices 130, and input/output (I/O) devices 132 for activity state data 150 (e.g., one or more computing metrics indicative of whether the hardware computing resources 108 are in an active state or an idle state).

For example, in accordance with the presently disclosed embodiments, the processor(s) 112 detect, based on the activity state data 150, an inactivity state (e.g., idle state) of one or more of the processors 122 (e.g., CPUs, GPUs, AI accelerators), memory 124, the storage 126 (e.g., databases), the bare metal servers 128, the network devices 130, or the I/O devices 132. In particular embodiments, upon the processor(s) 112 detecting an inactivity state (e.g., idle state) of one or more of the hardware computing resources 108, the processor(s) 112 may then generatively present sequences of different decoy data 152 (e.g., “fake” data) to be processed by one or more of the hardware computing resources 108 in response to an execution of one or more adversarial user interactions 148 with the hardware computing resources 108.

In particular embodiments, in response to an initiation of the execution of adversarial user interactions 148 with the hardware computing resources 108, the processor(s) 112 may then execute one or more generative machine-learning models 164 (e.g., including the adversarial user detector 166) trained to identify an adversarial user and to associate with the adversarial user each of the sequences of different decoy data 152 and the execution of adversarial user interactions 148. In one embodiment, the one or more generative machine-learning models 164 may include one or more of a language model (LM), a large language model (LLM), a bidirectional and auto-regressive transformer (BART) model, a bidirectional encoder representations for transformer (BERT) model, or a generative pre-trained transformer (GPT) model.

For example, in particular embodiments, the one or more generative machine-learning models 164 may be trained based on a training data set of user data 142 and user interactions 146 that may be associated with any number of legitimate users 102 interacting with the software application 138 via a computing device 104. For example, in one embodiment, the one or more generative machine-learning models 164 may be trained to identify an adversarial user based on whether the adversarial user interactions 148 deviates from the training data set of user data 142 and user interactions 146. In particular embodiments, the one or more generative machine-learning models 164 may be further trained based on a training data set of hardware computing resource operational data 172 associated with the normal and expected operations of the hardware computing resources 108.

In particular embodiments, the processor(s) 112 may further identify one or more performable tasks 170 (e.g., “real” or “legitimate” computing tasks) associated with the software application 138 to be executed by one or more of the hardware computing resources 108. For example, in some embodiments, while one or more of the hardware computing resources 108 are in the inactivity state (e.g., idle state), and thus processing the sequences of different decoy data 152 (e.g., “fake” data), the processor(s) 112 may receive an indication of one or more performable tasks 170 to be executed. In accordance with the presently disclosed embodiments, the processor(s) 112 may then forgo generatively presenting the sequences of different decoy data 152 for processing by the hardware computing resources 108 while the one or more performable tasks 170 (e.g., “real” or “legitimate” tasks) are executed by the hardware computing resources 108.

### Hardware Computing Resources

In particular embodiments, the hardware computing resources 108 may include any hardware computing resources across the system 100 that may be utilized to support the execution of the software application 138 and the one or more performable tasks 170. For example, in one embodiment, the hardware computing resources 108 may include one or more hardware computing resources that may be external to the cloud computing system 106. In another embodiment, the hardware computing resources 108 may include one or more hardware computing resources internal to the cloud computing system 106, such as hardware computing resources at the hardware layer of the cloud computing system 106.

As further depicted, in accordance with the presently disclosed embodiments, the hardware computing resources 108 may include one or more processors 122 (e.g., CPUs, GPUs, AI accelerators), memory 124 (e.g., ROM, RAM, TCAM, DRAM, SRAM, and so forth), storage 126 (e.g., one or more databases), bare metal servers 128 (e.g., one or more physical servers), network devices 130 (e.g., hubs, routers, gateways, NICs, modems, repeaters, WAPs, and so forth), or other similar hardware computing resources 108 that may be vulnerable to adversarial attacks during the time in which the hardware computing resources 108 enter into an inactivity state (e.g., idle state).

### Generating Decoy Data Based on the Detection of Idle States of Computing Systems

Embodiments of the present disclosure discuss techniques for generating decoy data based on the detection of idle states of computing systems.

FIG. 2 illustrates a diagram of an idle detection and decoy data generation architecture 200 for generating decoy data based on the detection of idle states of computing systems, in accordance with certain aspects of the present disclosure. In particular embodiments, the idle detection and decoy data generation architecture 200 may correspond to the cloud computing system 106 and may be executed by the processor(s) 112 as described above with respect to FIG. 1. As depicted, the idle detection and decoy data generation architecture 200 may include a number of computing resources including one or more processors 202 (e.g., central processing units (CPUs)), storage 204 (e.g., one or more databases), one or more network devices 206 (e.g., hubs, routers, gateways, network interface cards (NICs), modems, repeaters, wireless access points (WAPs), and so forth), and memory 208 (e.g., read-only memory (ROM), random-access memory (RAM), ternary content-addressable memory (TCAM), dynamic random-access memory (DRAM), static random-access memory (SRAM), and so forth).

In particular embodiments, as further depicted by the idle detection and decoy data generation architecture 200, the one or more processors 202, the storage 204, the one or more network devices 206, and the memory 208 may be communicatively coupled to the processor(s) 112, which may be utilized to perform an idle resource detection algorithm 210. For example, in particular embodiments, the processor(s) 112 may execute the idle resource detection algorithm 210 to ping (e.g., every few milliseconds) and monitor each of the one or more processors 202, the storage 204, the one or more network devices 206, and the memory 208 for activity state data 150. For example, in one embodiment, the processor(s) 112 may execute the idle resource detection algorithm 210 to ping and monitor the one or more processors 202, the storage 204, the one or more network devices 206, and the memory 208 for activity state data 150 and determine whether one or more of the one or more processors 202, the storage 204, the one or more network devices 206, or the memory 208 has entered into an inactivity state (e.g., an idle state or a period of time in which “real” and “legitimate” tasks are not being performed).

In particular embodiments, upon the processor(s) 112 determining an inactivity state (e.g., idle state) of one or more of the one or more processors 202, the storage 204, the one or more network devices 206, or the memory 208, the processor(s) 112 may further execute the idle resource detection algorithm 210 to compare the determined inactivity state to a predetermined threshold corresponding to a metric (e.g., processor 202 utilization, memory 208 allocation, I/O device or storage 204 access, network device 206 traffic, and so forth) of one or more of the one or more processors 202, the storage 204, the one or more network devices 206, or the memory 208 an activity state (e.g., active state).

In particular embodiments, upon the processor(s) 112 determining that the inactivity state (e.g., idle state) of one or more of the one or more processors 202, the storage 204, the one or more network devices 206, or the memory 208 satisfies the predetermined threshold, the processor(s) 112 may then execute a decoy data generation algorithm 212. For example, in particular embodiments, the decoy data generation algorithm 212 may include an automatic algorithm generation (AAG) model that may be executed by the processor(s) 112 to generatively present sequences of different decoy data 214 (e.g., “fake” data) to be processed by one or more of the one or more processors 202, the storage 204, the one or more network devices 206, or the memory 208.

Specifically, the processor(s) 112 may execute the decoy data generation algorithm 212 to provide sequences of different decoy data 214 (e.g., “fake” data) to one or more of the one or more processors 202, the storage 204, the one or more network devices 206, or the memory 208 to deceive and prompt a potential adversarial user (e.g., an attacker, an eavesdropper, or other similar adversarial user) to interact with the one or more processors 202, the storage 204, the one or more network devices 206, or the memory 208, for example, believing the aforementioned hardware computing resources 108 to be in the active state instead of actually being in the inactivity state (e.g., idle state).

For example, in particular embodiments, the sequences of different decoy data 214 (e.g., “fake” data) may include, for example, one or more randomized patterns of noise data that may be suitable for prompting an adversarial user to initiate an execution of one or more user interactions 148 with the sequences of different decoy data 214 (e.g., “fake” data). In one embodiment, the one or more randomized patterns of noise data may closely mimic intended user 102 (e.g., “real” or “legitimate” user) activities, such as opening and closing files, writing data to memory or storage, reading data from memory or storage, transmitting data packets over a network, launching and running one or more applications, connecting to a wireless communications network, and so forth.

In particular embodiments, upon an adversarial user initiating an execution of one or more user interactions 148 with the sequences of different decoy data 214 (e.g., “fake” data), the processor(s) 112 may execute an adversarial user detection algorithm 216 to identify the adversarial user and to associate with the adversarial user each of the sequences of different decoy data 214 and the execution of one or more user interactions 148. For example, in one embodiment, the adversarial use detection algorithm 216 may include one or more generative machine-learning models (e.g., adversarial user detector 166) that may be trained and executed by the processor(s) 112 to identify an adversarial user and to associate with the adversarial user each of the sequences of different decoy data 214 and the execution of one or more user interactions 148 as the adversarial user is performing the execution of one or more user interactions 148 with the one or more processors 202, the storage 204, the one or more network devices 206, or the memory 208.

For example, in particular embodiments, one or more generative machine-learning models 164 (e.g., adversarial user detector 166) may be trained on nominal and expected system behaviors or user interactions, thus allowing the one or more generative machine-learning models 164 (e.g., adversarial user detector 166) to accurately identify any deviations from expected usage patterns, behaviors, or interactions that may be indicative of an adversarial user. Specifically, the processor(s) 112 may execute the adversarial user detection algorithm 216 to monitor the one or more user interactions 148 to identify any unusual patterns or attempts by an adversarial user (e.g., an attacker, an eavesdropper, or other similar adversarial user) to exploit the one or more processors 202, the storage 204, the one or more network devices 206, or the memory 208 and/or the sequences of different decoy data 214 (e.g., “fake” data) for an adversarial use.

In particular embodiments, upon determining at least a partial completion of the execution of one or more user interactions 148 with the one or more processors 202, the storage 204, the one or more network devices 206, or the memory 208, the processor(s) 112 may then generate a log 218 of the identified adversarial user, the sequences of different decoy data 214, and the execution of the one or more user interactions 148. For example, in one embodiment, the log 218 may be stored and utilized to iteratively update the security policies, security profiles, and security intelligence associated with the one or more processors 202, the storage 204, the one or more network devices 206, and the memory 208.

In particular embodiments, as further depicted by the idle detection and decoy data generation architecture 200, the processor(s) 112 may identify one or more performable tasks 220 (e.g., “real” or “legitimate” tasks) to be executed by one or more of the one or more processors 202, the storage 204, the one or more network devices 206, or the memory 208. For example, in one embodiment, the processor(s) 112 may identify one or more performable tasks 220 (e.g., “real” or “legitimate” tasks) to be executed by one or more of the one or more processors 202, the storage 204, the one or more network devices 206, or the memory 208.

In response, the processor(s) 112 may then cause one or more of the one or more processors 202, the storage 204, the one or more network devices 206, or the memory 208 to transition from the from the inactivity state (e.g., idle state) back into the active state to execute the one or more performable tasks 220 (e.g., “real” or “legitimate” tasks). In particular embodiments, while the one or more performable tasks 220 (e.g., “real” or “legitimate” tasks) are executed by one or more of the one or more processors 202, the storage 204, the one or more network devices 206, or the memory 208, the processor(s) 112 may forgo generatively presenting the sequences of different decoy data 214 (e.g., “fake” data).

In this way, the processor(s) 112 may ensure that “real” or “legitimate” computing tasks are prioritized over any generation of sequences of different decoy data 214 (e.g., “fake” data). Specifically, by the processor(s) 112 prioritizing the execution of the one or more performable tasks 220 (e.g., “real” or “legitimate” tasks) over the generation of sequences of different decoy data 214 (e.g., “fake” data), the processor(s) 112 may ensure that the performance of the one or more processors 202, the storage 204, the one or more network devices 206, and the memory 208 are improved (e.g., in terms of CPU clock cycles, processing speed, memory allocation, storage capacity, network bandwidth, data throughput, and so forth) with respect to executing the one or more performable tasks 220 (e.g., “real” or “legitimate” tasks).

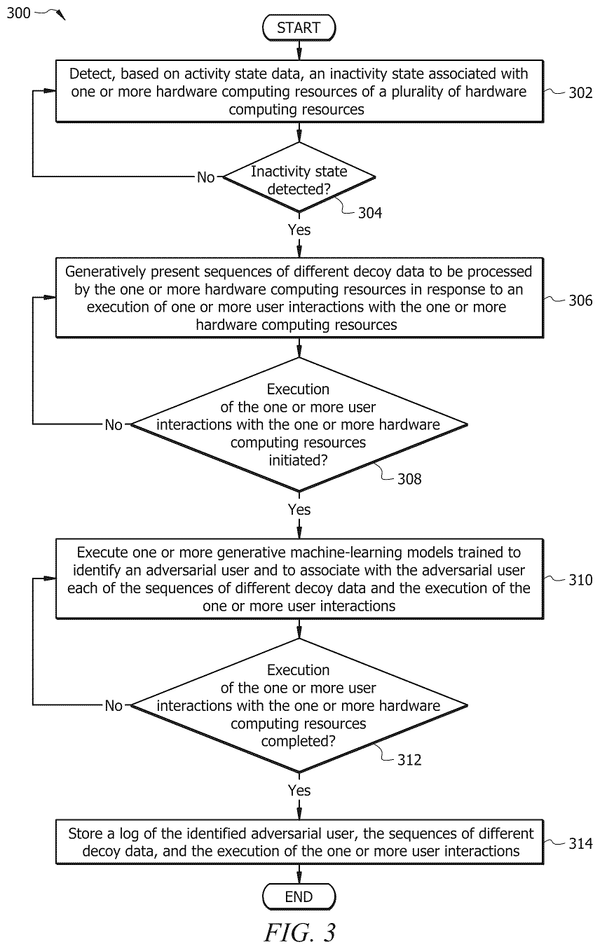

FIG. 3 illustrates a flowchart of an example method 300 for generating decoy data based on the detection of idle states of computing systems, in accordance with one or more embodiments of the present disclosure. The method 300 may be performed utilizing the one or more processor(s) 112 of cloud computing system 106 as described above with respect to FIG. 1. The method 300 may begin at block 302 with the processor(s) 112 detecting, based on activity state data, an inactivity state associated with one or more hardware computing resources of a plurality of hardware computing resources. For example, in one embodiment, the processor(s) 112 may execute the idle resource detection algorithm 210 to ping and monitor the one or more processors 202, the storage 204, the one or more network devices 206, and the memory 208 for activity state data 150 and determine whether one or more of the one or more processors 202, the storage 204, the one or more network devices 206, or the memory 208 has entered into an inactivity state (e.g., idle state).

The method 300 may then continue at decision 304 with the processor(s) 112 confirming whether the one or more hardware computing resources has entered into the inactivity state (e.g., an idle state). In one embodiment, in response to confirming that the one or more hardware computing resources has not entered into the inactivity state (e.g., at decision 304), the method 300 may return to block 302 as discussed above. On the other hand, in response to confirming that the one or more hardware computing resources has entered into the inactivity state (e.g., at decision 304), the method 300 may then continue at block 306 with the processor(s) 112 generatively presenting sequences of different decoy data to be processed by the one or more hardware computing resources in response to an execution of one or more user interactions with the one or more hardware computing resources.

For example, in one embodiment, the processor(s) 112 may execute the decoy data generation algorithm 212 may provide sequences of different decoy data 214 (e.g., “fake” data) to one or more of the one or more processors 202, the storage 204, the one or more network devices 206, or the memory 208 to deceive and prompt a potential adversarial user (e.g., an attacker, an eavesdropper, or other similar adversarial user) to interact with the one or more processors 202, the storage 204, the one or more network devices 206, or the memory 208, for example, believing the aforementioned hardware computing resources 108 to be in the active state instead of actually being in the inactivity state (e.g., idle state).

The method 300 may then continue at decision 308 with the processor(s) 112 confirming whether an execution of the one or more user interactions with the one or more hardware computing resources has been initiated. In one embodiment, in response to confirming that the execution of the one or more user interactions with the one or more hardware computing resources has not been initiated (e.g., at decision 308), the method 300 may return to block 306 as discussed above. On the other hand, in response to confirming that the execution of the one or more user interactions with the one or more hardware computing resources has been initiated (e.g., at decision 308), the method 300 may then continue at block 310 with the processor(s) 112 executing one or more generative machine-learning models trained to identify an adversarial user and to associate with the adversarial user each of the sequences of different decoy data and the execution of the one or more user interactions.

For example, in one embodiment, the processor(s) 112 may execute the adversarial user detection algorithm 216 may include one or more generative machine-learning models 164 (e.g., adversarial user detector 166) that may be trained and executed by the processor(s) 112 to identify an adversarial user and to associate with the adversarial user each of the sequences of different decoy data 214 and the execution of one or more user interactions 148 as the adversarial user is performing the execution of one or more user interactions 148 with the one or more processors 202, the storage 204, the one or more network devices 206, or the memory 208.

The method 300 may then continue at decision 312 with the processor(s) 112 confirming whether an execution of the one or more user interactions with the one or more hardware computing resources has been completed. In one embodiment, in response to confirming that the execution of the one or more user interactions with the one or more hardware computing resources has not been completed (e.g., at decision 312), the method 300 may return to block 310 as discussed above. On the other hand, in response to confirming that the execution of the one or more user interactions with the one or more hardware computing resources has been completed (e.g., at decision 312), the method 300 may then conclude at block 314 with the processor(s) 112 storing a log of the identified adversarial user, the sequences of different decoy data, and the execution of the one or more user interactions.

Specifically, in accordance with the presently disclosed embodiments, the processor(s) 112 may generate a log 218 of the identified adversarial user, the sequences of different decoy data 214, and the execution of the one or more user interactions 148. The log 218 may be stored and utilized to iteratively update the security policies, security profiles, and security intelligence associated with the one or more processors 202, the storage 204, the one or more network devices 206, and the memory 208.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system, comprising:
a memory configured to store activity state data associated with each of a plurality of hardware computing resources; and
one or more processors operably coupled to the memory and configured to:
detect, based at least in part on the activity state data, an inactivity state associated with one or more hardware computing resources of the plurality of hardware computing resources, and, in response:
generatively present sequences of different decoy data to be processed by the one or more hardware computing resources in response to an execution of one or more user interactions with the one or more hardware computing resources;
in response to an initiation of the execution of one or more user interactions with the one or more hardware computing resources, execute one or more generative machine-learning models trained to identify an adversarial user and to associate with the adversarial user each of the sequences of different decoy data and the execution of the one or more user interactions; and
in response to determining at least a partial completion of the execution of the one or more user interactions with the one or more hardware computing resources, store a log of the identified adversarial user, the sequences of different decoy data, and the execution of the one or more user interactions.

2. The system of claim 1, wherein the sequences of different decoy data comprise one or more randomized patterns of one or more of a processor utilization, a memory allocation, an input/output (I/O) device access, or a network device traffic.

3. The system of claim 1, wherein the sequences of different decoy data comprise one or more sets of noise data configured to prompt the adversarial user to complete the execution of the one or more user interactions with the sequences of different decoy data.

4. The system of claim 1, wherein the one or more generative machine-learning models comprises one or more of a language model (LM), a large language model (LLM), a bidirectional and auto-regressive transformer (BART) model, a bidirectional encoder representations for transformer (BERT) model, or a generative pre-trained transformer (GPT) model.

5. The system of claim 1, wherein the plurality of hardware computing resources is configured to support an execution of at least one software application, and wherein the one or more processors are further configured to:
prior to executing the one or more generative machine-learning models, train the one or more generative machine-learning models based at least in part on a training data set of user data associated with one or more intended users of the at least one software application and a training data set of operational data associated with the one or more hardware computing resources.

6. The system of claim 5, wherein the one or more processors are further configured to execute the one or more generative machine-learning models further trained to identify the adversarial user based at least in part on whether the execution of the one or more user interactions deviates from the training data set of user data associated with the one or more intended users of the at least one software application.

7. The system of claim 5, wherein the one or more processors are further configured to:
identify one or more performable tasks to be executed by the one or more hardware computing resources, wherein the one or more performable tasks is associated with the execution of the at least one software application; and
while the identified one or more performable tasks is executed by the one or more hardware computing resources, forgo generatively presenting the sequences of different decoy data for processing by the one or more hardware computing resources.

8. A method, comprising:
detecting, based at least in part on activity state data, an inactivity state associated with one or more hardware computing resources of a plurality of hardware computing resources, and, in response:
generatively presenting sequences of different decoy data to be processed by the one or more hardware computing resources in response to an execution of one or more user interactions with the one or more hardware computing resources;
in response to an initiation of the execution of one or more user interactions with the one or more hardware computing resources, executing one or more generative machine-learning models trained to identify an adversarial user and to associate with the adversarial user each of the sequences of different decoy data and the execution of the one or more user interactions; and
in response to determining at least a partial completion of the execution of the one or more user interactions with the one or more hardware computing resources, storing a log of the identified adversarial user, the sequences of different decoy data, and the execution of the one or more user interactions.

9. The method of claim 8, wherein the sequences of different decoy data comprise one or more randomized patterns of one or more of a processor utilization, a memory allocation, an input/output (I/O) device access, or a network device traffic.

10. The method of claim 8, wherein the sequences of different decoy data comprise one or more sets of noise data configured to prompt the adversarial user to complete the execution of the one or more user interactions with the sequences of different decoy data.

11. The method of claim 8, wherein the one or more generative machine-learning models comprises one or more of a language model (LM), a large language model (LLM), a bidirectional and auto-regressive transformer (BART) model, a bidirectional encoder representations for transformer (BERT) model, or a generative pre-trained transformer (GPT) model.

12. The method of claim 8, wherein the plurality of hardware computing resources is configured to support an execution of at least one software application, the method further comprising:
prior to executing the one or more generative machine-learning models, training the one or more generative machine-learning models based at least in part on a training data set of user data associated with one or more intended users of the at least one software application and a training data set of operational data associated with the one or more hardware computing resources.

13. The method of claim 12, further comprising executing the one or more generative machine-learning models further trained to identify the adversarial user based at least in part on whether the execution of the one or more user interactions deviates from the training data set of user data associated with the one or more intended users of the at least one software application.

14. The method of claim 12, further comprising:
identifying one or more performable tasks to be executed by the one or more hardware computing resources, wherein the one or more performable tasks is associated with the execution of the at least one software application; and
while the identified one or more performable tasks is executed by the one or more hardware computing resources, forgoing generatively presenting the sequences of different decoy data for processing by the one or more hardware computing resources.

15. A non-transitory computer-readable medium storing instructions that, when executed by one or more processors, cause the one or more processors to:
detect, based at least in part on activity state data, an inactivity state associated with one or more hardware computing resources of a plurality of hardware computing resources, and, in response:
generatively present sequences of different decoy data to be processed by the one or more hardware computing resources in response to an execution of one or more user interactions with the one or more hardware computing resources;
in response to an initiation of the execution of one or more user interactions with the one or more hardware computing resources, execute one or more generative machine-learning models trained to identify an adversarial user and to associate with the adversarial user each of the sequences of different decoy data and the execution of the one or more user interactions; and
in response to determining at least a partial completion of the execution of the one or more user interactions with the one or more hardware computing resources, store a log of the identified adversarial user, the sequences of different decoy data, and the execution of the one or more user interactions.

16. The non-transitory computer-readable medium of claim 15, wherein the sequences of different decoy data comprise one or more randomized patterns of one or more of a processor utilization, a memory allocation, an input/output (I/O) device access, or a network device traffic.

17. The non-transitory computer-readable medium of claim 15, wherein the sequences of different decoy data comprise one or more sets of noise data configured to prompt the adversarial user to complete the execution of the one or more user interactions with the sequences of different decoy data.

18. The non-transitory computer-readable medium of claim 15, wherein the one or more generative machine-learning models comprises one or more of a language model (LM), a large language model (LLM), a bidirectional and auto-regressive transformer (BART) model, a bidirectional encoder representations for transformer (BERT) model, or a generative pre-trained transformer (GPT) model.

19. The non-transitory computer-readable medium of claim 15, wherein the plurality of hardware computing resources is configured to support an execution of at least one software application, and wherein the instructions further cause the one or more processors to:
prior to executing the one or more generative machine-learning models, train the one or more generative machine-learning models based at least in part on a training data set of user data associated with one or more intended users of the at least one software application and a training data set of operational data associated with the one or more hardware computing resources.

20. The non-transitory computer-readable medium of claim 19, wherein the instructions further cause the one or more processors to:
identify one or more performable tasks to be executed by the one or more hardware computing resources, wherein the one or more performable tasks is associated with the execution of the at least one software application; and
while the identified one or more performable tasks is executed by the one or more hardware computing resources, forgo generatively presenting the sequences of different decoy data for processing by the one or more hardware computing resources.
